(19) United States
(12) Patent Application Publication
(10) Pub. No.: US 2007/0016432 A1
(43) Pub. Date: Jan. 18, 2007

(54) Performance and cost analysis system and method

(76) Inventors: Bryan N. Piggott, Gambrills, MD (US); Michael J. Mercer, Vienna, VA (US)

Correspondence Address: GIBB LP. LAW FIRM, LLC, 2568-A RIVA ROAD SUITE 304, ANNAPOLIS, MD, 21401, US

(21) Appl. No.: 11/183,328

(22) Filed: Jul. 15, 2005

(51) Int. Cl. G06Q 99/00; G06F 19/00; G06F 17/00

(52) U.S. Cl. 705/1; 705/400; 705/500; 700/107; 700/97; 700/99

(57) ABSTRACT

A performance and cost analysis system and method comprises an output system; a calculation system operatively inputting data to the output system, wherein the calculation system is adapted to process system engineering and cost parameters of a system under analysis, make changes to the system engineering and cost parameters of the system under analysis, and calculate effects of factors influencing the system under analysis based on the changes made to the system engineering and cost parameters; an input model system operatively inputting data to the calculation system; and an input data system operatively inputting data to the calculation system and the output system, wherein the output system is adapted to identify changes to the system under analysis based on the calculated effects, and calculate a life cycle cost of the system under analysis based on the identified changes. Preferably, the system under analysis comprises hardware architecture components.

A portion of the disclosure of this patent document includes material that is subject to copyright protection. The copyright owner has no objection to the facsimile reproduction by anyone of this patent document or the patent disclosure, as it appears in the U.S. Patent and Trademark Office patent file or records, but otherwise reserves all copyright rights whatsoever.

### BACKGROUND OF THE INVENTION

1. Field of the Invention

The embodiments of the invention generally relate to computer software, and, more particularly, to analytical software used for forecasting business systems cost and computer architecture life cycles and performing trade analysis regarding system performance and cost.

2. Description of the Related Art

Various cost estimation tools exist which can be used to predict the cost of designing, developing, and testing a software system, an electronics system, or a mechanical device. However, most conventional cost estimation tools generally fail to focus on operational aspects of computer systems and typically make no effort to recommend hardware or predict the cost of hardware necessary for the system to operate correctly. Additionally, the conventional tools generally do not provide ample results if the input data is limited, which is often the situation in early phases of systems engineering problems. Accordingly, there remains a need for a novel technique that can predict the cost for complex computerized systems based on limited data and be the vehicle for performing trade analysis while varying operational and system parameters.

### SUMMARY OF THE INVENTION

In view of the foregoing, an embodiment of the invention provides an analytic system comprising an output system; a calculation system operatively inputting data to the output system, wherein the calculation system is adapted to process system engineering and cost parameters of a system under analysis, make changes to the system engineering and cost parameters of the system under analysis, and calculate effects of factors influencing the system under analysis based on the changes made to the system engineering and cost parameters; an input model system operatively inputting data to the calculation system; and an input data system operatively inputting data to the calculation system and the output system, wherein the output system is adapted to identify changes to the system under analysis based on the calculated effects, and calculate a life cycle cost of the system under analysis based on the identified changes. Preferably, the system under analysis comprises hardware architecture components, wherein the factors may comprise a cost effectiveness, space consumption, and power consumption of the system under analysis.

The identified changes to the system under analysis based on the calculated effects may comprise hardware changes necessary to allow a software system of the system under analysis to function properly; and a cost associated with implementing the hardware changes, wherein the identified changes to the system under analysis based on the calculated effects may further comprise any of a bill of materials of the hardware changes; an estimated time of deployment of the hardware changes; an estimated cost of deployment of the hardware changes; and an estimated operational cost of implementing the hardware changes.

Preferably, the system engineering and cost parameters comprise usage patterns comprising any of mission activity data related to business activities of the system under analysis, hardware architectural data of the system under analysis, and system engineering data of the system under analysis, wherein the mission activity data related to business activities of the system under analysis may comprise any of a frequency of execution of a component and function required for mission activities; permanent hardware storage required for execution of the mission activities; and communication components required for the execution of the mission activities. Preferably, the system engineering and cost parameters comprise any of logical architecture, a logical data model, operations data, hardware cost data, software cost data, and a deployment plan.

Another aspect of the invention provides a system comprising means for processing system engineering and cost parameters of a system under analysis; means for making changes to the system engineering and cost parameters of the system under analysis; means for calculating effects of factors influencing the system under analysis based on the changes made to the system engineering and cost parameters; means for identifying changes to the system under analysis based on the calculated effects; and means for calculating a life cycle cost of the system under analysis based on the identified changes, wherein the system under analysis preferably comprises hardware architecture components, and wherein the factors may comprise a cost effectiveness, space consumption, and power consumption of the system under analysis. Preferably, the system engineering and cost parameters comprise usage patterns comprising any of mission activity data related to business activities of the system under analysis, hardware architectural data of the system under analysis, and system engineering data of the system under analysis. Moreover, the system engineering and cost parameters may comprise any of logical architecture, a logical data model, operations data, hardware cost data, software cost data, and a deployment plan.

Another embodiment of the invention provides a method of conducting system engineering optimization for a system under analysis, and a program storage device readable by computer, tangibly embodying a program of instructions executable by the computer to perform the method of conducting system engineering optimization for a system under analysis, wherein the method comprises processing system engineering and cost parameters of the system under analysis; making changes to the system engineering and cost parameters of the system under analysis; calculating effects of factors influencing the system under analysis based on the changes made to the system engineering and cost parameters; identifying changes to the system under analysis based on the calculated effects; and calculating a life cycle cost of the system under analysis based on the identified changes.

Preferably, the system under analysis comprises hardware architecture components and the factors may comprise a cost effectiveness, space consumption, and power consumption of the system under analysis. The identified changes to the system under analysis based on the calculated effects preferably comprises hardware changes necessary to allow a software system of the system under analysis to function properly; and a cost associated with implementing the hardware changes.

Additionally, the identified changes to the system under analysis based on the calculated effects may further comprise any of a bill of materials of the hardware changes; an estimated time of deployment of the hardware changes; an estimated cost of deployment of the hardware changes; and an estimated operational cost of implementing the hardware changes. Preferably, the system engineering and cost parameters comprise usage patterns comprising any of mission activity data related to business activities of the system under analysis, hardware architectural data of the system under analysis, and system engineering data of the system under analysis, wherein the mission activity data related to business activities of the system under analysis preferably comprises any of a frequency of execution of a component and function required for mission activities; permanent hardware storage required for execution of the mission activities; and communication components for the execution of the mission activities. Furthermore, the system engineering and cost parameters may comprise any of logical architecture, a logical data model, operations data, hardware cost data, software cost data, and a deployment plan.

These and other aspects of the embodiments of the invention will be better appreciated and understood when considered in conjunction with the following description and the accompanying drawings. It should be understood, however, that the following descriptions, while indicating preferred embodiments of the invention and numerous specific details thereof, are given by way of illustration and not of limitation. Many changes and modifications may be made within the scope of the embodiments of the invention without departing from the spirit thereof, and the embodiments of the invention include all such modifications.

### BRIEF DESCRIPTION OF THE DRAWINGS

The embodiments of the invention will be better understood from the following detailed description with reference to the drawings, in which:

FIG. 1 illustrates a schematic diagram of a performance/cost analysis system according to an embodiment of the invention;

FIGS. 2 through 8 illustrate schematic diagrams of various performance model worksheets according to the embodiments of the invention;

FIG. 9 illustrates a schematic diagram of a deployment plan example according to an embodiment of the invention;

FIG. 10 illustrates a flow diagram illustrating a preferred method according to an embodiment of the invention;

FIG. 11 illustrates a schematic diagram of a computer system according to an embodiment of the invention; and

FIG. 12 illustrates a C4ISR architecture framework implementation process used in conjunction with the embodiments of the invention.

### DETAILED DESCRIPTION OF PREFERRED EMBODIMENTS OF THE INVENTION

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention.

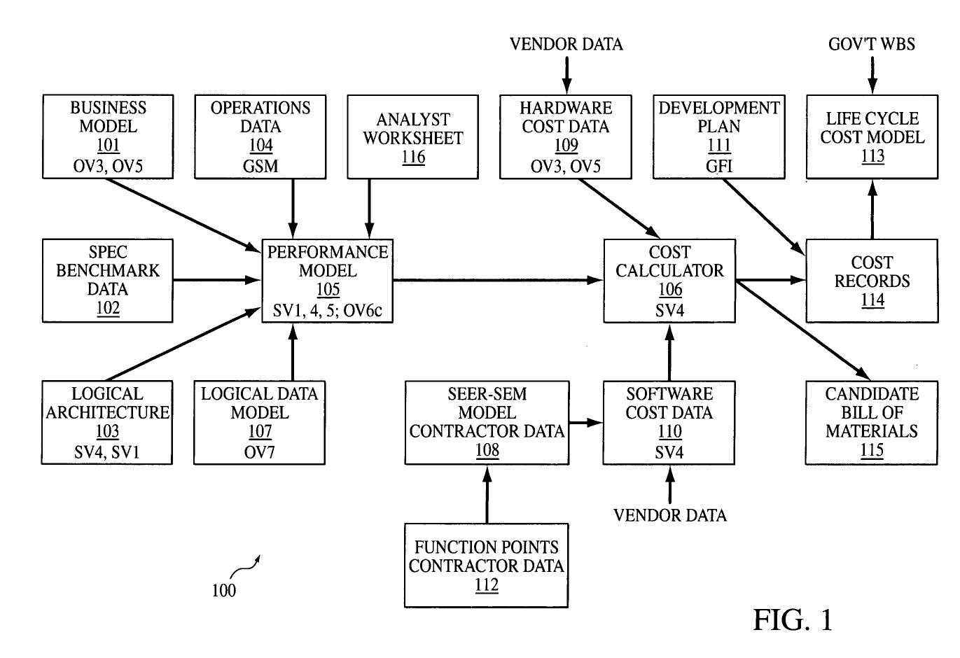

As mentioned, there remains a need for a technique to predict the cost and to perform trade analysis relative to cost, for complex computerized systems either based on limited data or in the early phases of a system development. The embodiments of the invention achieve this by providing a system and method upon which one can build a model that directly represents mission activities and architectural components in order to study the impact of changes in architecture and mission demand. A component of the embodiments of the invention is that it allows one to quickly build a model that represents the mission workload and easily demonstrate that it fairly represents the intended use of the target system engineering decisions and architectural products. Each cost record generated by the performance and cost analysis model provided by the embodiments of the invention can be directly traced back to one or more mission activities and the system components necessary for the execution of that activity. Referring now to the drawings, and more particularly to FIGS. 1 through 12 where similar reference characters denote corresponding features consistently throughout the figures, there are shown preferred embodiments of the invention.

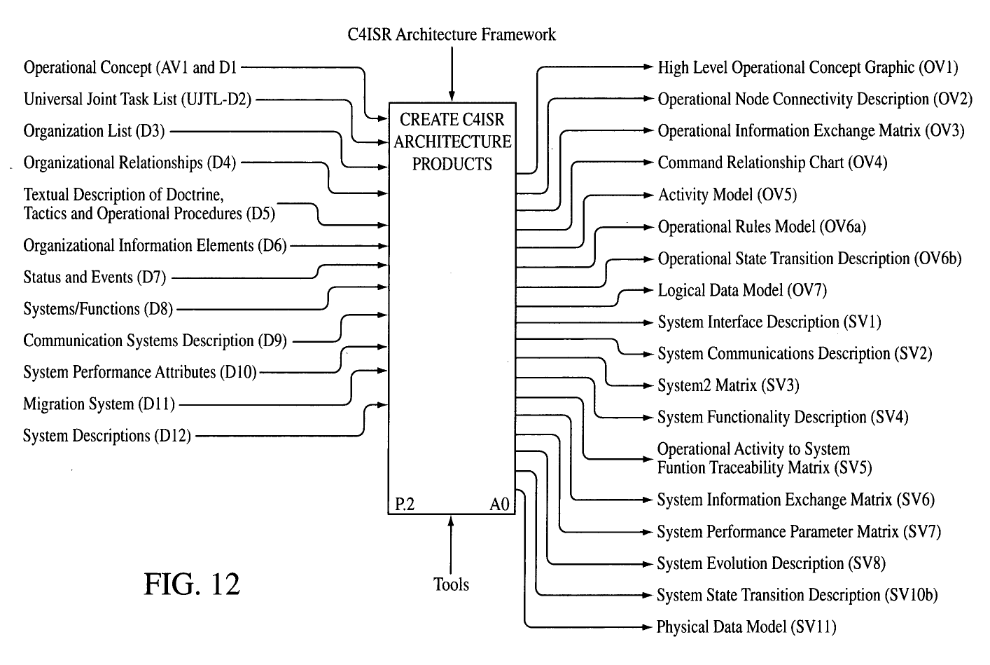

FIG. 1 illustrates a system/model 100 provided by an embodiment of the invention embodied as a loosely coupled set of system models that share information in the process of generating an LCCE (life cycle cost estimate). The models represented in the system 100 generally include systems for input models, systems for input data, calculation systems, and output systems. Four of the models represented in the system 100 are shown based on the well-known United States Department of Defense architecture framework (DoDAF), an implementation process of which is further illustrated in FIG. 12 from the viewpoint of computer architecture developers. It should be noted that any architectural process can provide input models so long as they represent business processes and a system architecture structure. Again, with reference to FIG. 1, the systems for input models include a business model system 101 that describe mission activities, a logical architecture system 103 that describes system components and functions, an operations data system 104 that may describe goals, conditions and constraints under which the target system must operate and a logical data model system 107. Each of these systems serves as an input to a master performance model 105.

The systems for input data include SPEC (Standard Performance Evaluation Corporation) benchmark data 102 that also serves as an input to the master performance model 105, hardware cost data 109, software cost data 110, function points (contractor data) 112, and a deployment plan 111. The Standard Performance Evaluation Corporation (SPEC) is a non-profit corporation formed to establish, maintain, and endorse a standardized set of relevant benchmarks that can be applied to the newest generation of high-performance computers. The calculation systems include the master performance model 105, a cost calculator 106, and a SEER-SEM® (Software Evaluation and Estimation of Resources Software Estimating Model available from Galorath, Inc., CA, USA) cost estimation model 108.

SEER-SEM® is a commercial tool developed to estimate the effort, cost, staffing, and risk associated with software development. To provide these outputs, one provides size, personnel, environment, complexity, and constraints to the model. SEER-SEM® has a variety of knowledge bases incorporated in the model that will provide default settings for all but the size parameters once the project is characterized. One may characterize the program by selecting the application platform, application type, acquisition method, development method, development standard, and commercial off-the-shelf (COTS) component types from a list, then all that remains is to represent the size. Size can be provided in source lines of code (SLOC) or as function points. These are further characterized as new, re-used, or COTS. SEER-SEM® provides uncertainty ranges for the cost and schedule outputs.

SPEC develops suites of benchmarks and also reviews and publishes submitted results from member organizations and other benchmark licensees. SPEC rating can be effectively used to directly compare the capability of different hardware for the same application. In accordance with the embodiments of the invention, the performance demand of each of the components of the logical architecture 103 is characterized in terms of SPEC-INT seconds or SPEC-FP seconds, integer and floating point applications respectively.

As mentioned, the business model 101, SPEC benchmark data 102, logical architecture 103, operations data 104, and logical data model 107 all serve as inputs into the performance model 105, which together with the hardware cost data 109 and software cost data 110, serve as inputs to the cost calculator 106. The function points 112 serves as an input into the SEER-SEM® model 108, which in turn serves as an input into the software cost data 110. Each of the hardware cost data 109 and software cost data 110 has, as inputs, vendor data.

The system 100 generally includes three end outputs, which are generally produced with Microsoft® Visual Basic® scripts: life cycle cost model 113, cost records 114, and a candidate bill of materials (BOM) 115. The deployment plan 111 along with the output of the cost calculator 106 serves as an input to the cost records 114, which in turn serves as an input to the life cycle cost model 113. The cost calculator 106 also serves as an input to the candidate of bill of materials 115.

The business model 101 represents the mission activities satisfied by the system 100. The business model 101 comprises execution frequency data and any conditional execution rules and preferably includes information describing the execution relationship among the various mission activities. For example, if mission activity (a) runs, then mission activity (b) must also be executed. The embodiments of the invention also provide a tool called the Analyst Worksheet 116 to support the determination of the execution frequency. The Analyst Worksheet 116 is embodied as a matrix comprised of mission activities as the rows and types of system users as the columns. Each column is allocated eight hours (a normal shift) and the time is distributed among the various mission activities such that the eight hours are consumed. Each of the mission activities is also assigned a number of system-searches that will be accomplished within an hour. These values are combined arithmetically to result in a number representing the frequency of execution per second/per user for each of the mission activities. When this table is completed, it represents all classes of users, and the mission activity load on the system can be determined as the product of the count of each type of user and the frequency per second/per user. The operations data 104 includes a body of knowledge that represents data sources, ingest rates and critical processing requirements for 100 of the system environment including the conditions under which these may change as well as the volumes and sizes of output data produced by the target system.

The SPEC benchmark data 102 includes a commercial benchmark used to compare the effectiveness of computers for specific types of applications. For example, estimates of SPEC demand could be used to forecast the size of a machine necessary to execute a system component and function. The logical architecture 103 represents the system components and functions needed to satisfy the mission activities. Either the logical architecture 103 includes an estimate of each component and function's computer demand, permanent storage, and external communication or, the developers of the model must make estimates of these values in order for the embodiments of the invention to function as intended. The logical architecture 103 provides means to associate system component and functions to specific hardware platforms. In the course of designing a system, engineers must make decisions as to how many computers to use and which component and functions to execute on the various computers. These decisions are generally made to support efficiency of execution in the case that multiple component and functions perform on the same computer. The embodiments of the invention provide a means to represent the engineer's choices as to mapping of system component and functions to computers; and further make it practical to predict the impact of various configurations to overall life cycle cost thus supporting trade analysis of a system component and/or a system function allocation to computer platforms.

The logical data model 107 is used to aid in predicting permanent storage generation for each of the system component and functions and aids in understanding the overhead associated with data management in the system under analysis. The performance model 105 provides an intersection of system component and functions and mission activities, characterizes the execution relationship of mission activities to each other, characterizes the execution relationship of system component and functions to each other, supports allocation of component and functions to physical platforms, and produces total execution count, storage, and external communications by system component and function. The developer of a performance and cost analysis model preferably record the relationship of each system component and function to each mission activity in the model. These relationships might be characterized as in the example of the following language:

“When mission activity (a) is executed then system component and functions 3, 17, 43, and 192 must execute one time each. When system component and function 3 is executed then 100 bytes of permanent storage are required and 100 bytes of data is communicated to an outside entity.” Each mission activity: component/function pair is considered in the construction of the model provided by the embodiments of the invention.

Several additional constraints, requirements or conditions are recorded in model 105 that affect calculations later in the execution of the model 105 (data retention, software redundancy, hardware redundancy, hardware reserve capacity, cost scaling factor, and hardware system override; there are two flags that tell the model 105 whether to include development costs and whether there is a constraint on hardware replacement)

The embodiments of the invention are designed to support modeling of system environments of varying complexities ranging from single site deployments to multi-site, distributed processing deployments. Each of the sites can have different characteristics and perform different mission activities but when executed together satisfy an overall system mission requirement. The deployment plan 111 indicates when to have each site installed and operational; it is possible to deploy each site in increments that are convenient to the developer or to the customer. An overall cost curve can be generated based on the deployment plan 111. This supports management determinations of whether a deployment plan can be afforded or if more or fewer sites must be deployed in a particular period of time based on funding profiles. The hardware cost data 109 includes a list of candidate hardware, which the embodiments of the invention will select from and further includes system environmental data, cost data, use data, and support data. The software cost data 110 is organized on system component and functions and records commercial products selected by system engineers for use in the execution of system component and functions. It also records development/integration cost by system component and function, and records environmental, cost, use, and support data for COTS components.

The SEER-SEM® model 108 is constructed based on system component and functions and elements constructed as developmental, re-use or COTS components. The function points 112 represent the software volume required to be developed and/or integrated for system component and functions; function points are generally derived from system requirements. The cost calculator 106 combines or integrates the data provided to it and calculates cost by component and function for development, deployment, operations, and recapitalization. Furthermore, it includes a macro which chooses hardware to meet mission activity load with a multi-variant selection process. Generally, the embodiments of the invention considers three factors in making hardware choices, each of these factors may be weighted as to importance: (1) the ratio of performance capacity (SPEC Marks) to cost; (2) the space consumed for placement of the computers; and (3) the power requirements for the computers to operate. A composite score is calculated considering each of the factors, whereby the hardware with the best score is included in the cost calculator 106.

The embodiments of the invention provide an LCCE 113 for a point solution or a range of solutions. Intermediate results available from the master performance model 105 directly support development of the cost analysis requirements description (CARD) with volume data and a candidate bill of materials 115. The LCCE model 113 has a record of the recommended installation labor, support labor and training for each unique piece of hardware and each software component.

Each instantiation of the model 100 is unique to the program it represents since each system may serve a different mission purpose and may have unique system architecture: even if the mission purpose and system architecture are identical each instance of the model 100 may be different because of mission frequency differences or different factor settings such as the hardware override. As further described below, the system 100 provided by an embodiment of the invention provides the means to: (a) adjust mission use patterns by changing the Analyst Worksheet 116; (b) change data settings (source, volume, and retention requirements); (c) modify settings or adjusting equations in the master performance model 105; and (d) change components of a system and their ability to do work in order to observe changes in life-cycle cost. Many other parameters can be adjusted in addition to these. Parameters are typically associated with either system component and functions or cost factors. In the system 100, users' needs are expressed in the business model 101 as business processes (or mission activities) with some associated frequency rules. The model determines the size of the system required to meet the expressed frequency of demand with the component and functions expressed in the logical architecture 103. A preferred source for business processes is the OV5 available from the United States Department of Defense Architectural Framework (DODAF, sometimes known as C4ISR products). A preferred source for the component and functions is the SV4 also available from the U.S. DoDAF.

The system 100 simulates, in the performance model 105, the set of component and functions (logical architecture 103) necessary to complete one instance of each business process (business model 101). The relationships in the performance model 105 describe which component and functions participate in a business process, the extent of participation (how many executions), permanent storage requirements, and external communications required. The system 100 provides the means to describe which system component and functions operate on the same physical platform to support a selection of appropriate hardware later in the model. The system 100 accomplishes this by accepting a system number for each system component and function, wherein component and functions with the same system number must operate on the same physical computer platform. The model can be run to simulate an individual site or it can simulate an entire enterprise consisting of many sites. The products of the cost accumulator (cost calculator) 106 are a candidate BOM 115 and cost records 114 for each intersection of the system component and functions and elements-of-cost. Cost records 114 are structured as a relational table to provide for examination of the system cost, using a structured query language (SQL), after execution of the system 100. The life cycle cost model 113 is generated from the cost records 114 after a model run. The BOM 115 includes type, quantity, and cost of all purchased hardware, commercial software, and storage. Finally, the model has sufficient information to estimate other key enterprise costs such as hardware and software maintenance, installations costs, operating costs, etc. The model identifies each of these as cost records 114.

The system/model 100, as depicted in FIG. 1, represents one site, or one instance of a system. Successive executions of the model, with different input data, provides for representation of a multi-site enterprise or a system-of-systems analysis. For example, the model has been experimentally used to examine environments of more than 60 physical sites to date. However, there is no practical limit to the number of sites/systems that can be evaluated. Each of the sites or systems can also be represented as releases with changing functional and operating capability, thereby adding to the flexibility achieved with the modeling approach provided by the embodiments of the invention. In the event of a multi-site deployment, the deployment plan 111 serves as the means of communicating which sites are to be operational at which time. The deployment plan 111 is used as the execution template for the suite of sites/systems. Each of the cost records 114 comprises an identification of the site and/or release along with specific cost values. The post analysis of the cost records 114 is constructed for each system represented to answer the specific questions of interest and to accommodate special needs.

Each of the model components/systems depicted in FIG. 1 is independent and influence the overall model in different ways. Preferably, the system 100 operates with the U.S. DoDAF. However, the embodiments of the invention may work with other frameworks, and as such the embodiments of the invention are not limited to any particular framework.

The business models 101 that are preferred to be used in the system 100 are adapted from tools such as System Architect 2001™ available from Popkin Software, NY, USA; Rational Rose™ available from International Business Machines, NY, USA; and Core™ available from Vitech Corporation, VA, USA. These business models are preferred because they are part of an integrated suite of architecture characterization that helps to assure completeness and consistency in design. However, any representation of the mission activities in the business models 101 can be used so long as one can relate the logical architecture components 103 to mission needs. For illustrative purposes, the remainder of the discussion will be based on the DoDAF that is mandated for major U.S. Department of Defense procurements.

The business model 101 is represented by the OV5, which is the operational activity model. It describes the operations that are normally conducted in the course of achieving a mission or a business goal. It describes capabilities, operational activities, input/output flows between activities and input/output flows to/from activities that are outside the scope of the represented architecture. The OV5 is generally represented as a hierarchy and/or a flow diagram. In the case of a hierarchy, the system 100 represents the leaf nodes of the hierarchy. For a flow diagram, the system 100 represents the lowest level of activity. The business model 101 is not a functioning part of the system 100, but as previously mentioned, is an input to the performance model 105. These leaf nodes, or lowest level activities, are the column headings for the master performance model 105. Each column heading has three sub-headings so that there are three columns for each mission activity: one each for frequency, permanent storage required, and external communications required.

The logical architecture 103 is primarily represented by the SV4, the system component and function description. It documents the system functional hierarchy, system component and functions and the data that flows between them. It provides a clear description of necessary system data flows; ensures that functional connectivity is complete; and provides an appropriate level of detail. The SV4 is generally represented as a hierarchy and/or a flow diagram and is the counterpart to the OV5 in the master performance model 105. In the case of a hierarchy, the system 100 represents the leaf nodes of the hierarchy. For a flow diagram, the system 100 represents the lowest level of activity. The logical architecture 103 is not a functioning part of the system 100, but, as previously mentioned, serves as an input to the performance model 105. These leaf nodes, or lowest level activities, are the row headings for the master performance model 105. Engineering analysis has generally required that some additional system component and functions be identified for complete and accurate representation of the target system; these are added to 105 as rows and treated identically to the SV4 components. Aspects of the SV1, the system interface description, are used to describe the logical architecture 103.

The operations data 104 are the constants and relative values that are necessary to run the performance model 105. For a communication target system, the constants could represent input volumes, output volumes, sizes of various data elements at stages of processing, sizes of communication channels, etc. The data taken from the operations data 104 may include average session size (packets), average selected session size (packets), average selected application session size (packets), packet level metadata size (bytes), session level metadata size (bytes), application level metadata size (bytes), selected application metadata size (bytes), packet selection rate (percentage), session selection rate (percentage), application selection rate (percentage), input communication load factor (percentage), links/communication channel count, survey time per link (seconds), link characterizations/month, percent of sessions that are kept for analysis, packet survey selection rate (percent), and session survey selection rate (percent).

The remaining operations data 104 represents the amount of time that an analyst will spend operating in each vignette as represented in the performance model 105, and the frequency of system stimuli expected from an analyst as performed by the Analyst Worksheet 116. The time spent in each vignette and the count of stimuli are combined to represent the count of vignette activity per time period.

The logical data model 107 is represented by the OV7. It provides a definition of architecture domain data types, their attributes or characteristics, and their interrelationships. The OV7 is generally represented as an IDEF1X, but occasionally as and IDEF1, (wherein IDEF1X and IDEF1 are data modeling techniques that are typically used by many branches of the United States federal government). Of particular interest are data structures that are designed to support the business needs expressed by the OV5, and specifically, the volume of data that results in permanent storage and the volume of data that is transported out of the system location. The logical data model 107 is not a functioning part of the system 100, but as previously described, is an input to the equations and relationships in the performance model 105.

The performance model 105 is an element of the system 100 that integrates the information represented by the business model 101, SPEC benchmark data 102, logical architecture 103, operations data 104, and logical data model 107. The performance model 105 is preferably embodied as a matrix structured similarly to an SV5, which is the intersection of mission activities (OV5) and system component and functions (SV4). The SV5 identifies a system component's involvement in a mission activity.

As mentioned, the hardware cost data 109 is an input to the cost calculator/accumulator 106. The general purpose of the data 109 is to be used as a basis for selection of hardware for the execution of the component and functions described in the performance model 105. The hardware cost data 109 includes an ordered list (by SPEC capacity) of hardware choices available to the system 100 for selection into the bill of materials 115 and a selection engine (not shown); the installation and maintenance costs, and general and administrative (G&A) costs. Several classes of data 109 are recorded for each configuration relative to the hardware and are discussed in Table 1.

TABLE 1
Contents of the Hardware Data Cost Workbook

| Data Type | Discussion |
|---|---|
| SPEC Capacity | A measure of a computers ability to do work. These values are |
| | taken from www.spec.org when available, otherwise we use analogy |
| | based on the CPU chip. |
| System Code | An internal code that identifies the computer, computer count, |
| | CPU type and CPU count of that configuration. |
| Cost | Cost of configuration to the customer. |
| RAM Capacity | Maximum volume of RAM the configuration will accept. |
| Comms Capacity | Maximum volume of communication the configuration will |
| | manage. |
| Maintenance/Period | Maintenance cost as a percentage of purchase cost. |
| CPU Count | Number of CPUs present in the configuration. |
| Processor MHz | Speed of the CPUs within the configuration. |
| OS | Operating system(s) available for configuration. |
| Family | A code that identifies configurations that are upgradeable. |
| Ops Staff | Count of operations staff required to keep the configuration |
| | operational. |
| Rack Count | Space consumed by the configuration in μs. |
| Domain Count | Count of domains in the configuration. |
| Install Labor Hours | Number of hours required to install the configuration. |
| Power Draw (Watts) | Watts consumed during normal operations. |
| BTU/hr demand | Cooling capacity required to carry away waste heat for the |
| | configuration. |
| System Unit | Description of the computer incorporated in this configuration. |
| Count of System Units | Count used with system unit to construct the system code. |

The hardware cost data 109 includes the selection algorithms. The selections are based on one fixed factor, SPEC demand, and three weighted factors: cost/performance ratio, space required, and power required. Weights are user adjustable.

As mentioned, the software cost data 110 is an input to the cost calculator/accumulator 106. The general purpose of the data 110 is to identify the commercial software selected to provide a service and the software cost by component and function for integration or development (if necessary). Several classes of data 110 are recorded for each component and function relative to the hardware and are discussed in Table 2.

TABLE 2
Contents of the Software Data Cost Workbook

| | |
|---|---|
| Data Type | Discussion |
| Component | The name of the component and function from the SV4. |
| Code | The code from the SV4 SPEC. |
| Mark Slope | A measure of the system demand for the component and |
| | function. |
| SPEC Mark Intercept | The amount to bias the SPEC Mark Slope. |
| Vendor Name | Provider of commercial software selected for use within the |
| | component and function. |
| Product Name | Name of commercial software selected for use within the |
| | component and function. |
| Notes | Notes. |
| Fixed Cost | The fixed cost portion of a commercial software package. |
| License Terms | A code that identifies the licensing strategy of the vendor. |
| Variable Cost | The variable cost portion of a commercial software package. |
| Maintenance | Maintenance cost for software package, represented as a |
| | percentage of the purchase price. |
| Development Release # | This section is currently 10 columns where each column |
| | represents a period of time, usually a year. The data in the |
| | column represents the cost of development (if required) and |
| | integration. |
| Integration costs and | Independently estimated using a parametric model such as |
| development costs | SEER-SEM ® and recorded in the model for incorporation into |
| | the cost records. |
| Ops Staff | Count of operations staff required to keep the commercial |
| | software operational. |
| Install Staff | Number of hours required to install the software. |
| Function Training | Number of hours allocated for training on the use of the |
| | component and function. |
| App Training | Not currently used. |

SPEC capacity is a primary element of the prediction capability for hardware selection according to the embodiments of the invention. According to SPEC, a “SPECrate” is a throughput metric based on the SPEC CPU benchmarks (such as SPEC CPU95). This metric measures a system's capacity for processing jobs of a specified type in a given amount of time. This metric is used the same for multi-processor systems and for uni-processors. It is not necessarily a measure of how fast a processor might be, but rather a measure of how much work the one or more systems can accomplish. The other kinds of metrics from the SPEC CPU suites are “SPECratios”, which measure the speed at which a system completes a specified job. The “SPECratio” is a measure of how fast a given system might be. The “SPECratio” is calculated by taking the elapsed time that was measured for a system to complete a specified job, and dividing that into the reference time (the elapsed time that job took on a standardized reference machine). This measures how quickly, or more specifically: how many times faster than a particular reference machine, one system can perform a specified task.

The software cost data 110 also includes the G&A overhead costs for commercial software license purchases and software development. The final capability of this sheet allows for optimistic and pessimistic excursions in cost by setting percentages that adjust the cost of software purchase and/or software development/integration to show a range of cost instead of a point cost. The model 105 allows for an across the board percentage adjustment to assist in exploration of the cost, whereby this percentage adjustment is set in the performance model 105 and is a factor of all equations in the cost calculator 106

With regard to the function points 112. In order to predict the cost and schedule of developed software and integrated COTS software it is necessary to have an accurate measure of software volume. The traditional measure has been source lines of code (SLOC). However, this measure is generally only accurate when one can count the developed code, even then different users would count the SLOC in different ways. Function points 112 are a count of: inputs, outputs, interchanges, internal logical files, and external logical files according to a set of criteria established by the International Function Point Users Group (IFPUG).

The cost records 114 are the principal output of the system 100. The cost records 114 are in the form of rows of a relational table and are generated through the use of a macro by extracting data from the cost calculator 106. The records are fed into a database structure (not shown), such as, for example, an Oracle® database available from Oracle, Calif., USA. Once the cost records 114 are in the database, then the information there can be explored using SQL queries. A row of cost records data currently include the following attributes: site identification, release number, component and function name, type of cost (develop, deploy, operation, recap), element of cost (a decomposition of type of cost), period of cost (what time period is this cost for), units (count of cost item), unit cost, total cost, replace flag (flag used by subsequent software to determine when to replace hardware), and hardware family (an indicator, used by subsequent software, of whether hardware can be upgraded rather than replaced).

The candidate bill of materials 115 provides hardware, software, and storage volumes that will satisfy the system performance requirements recorded in the performance model 105. The bill of materials 115 is generated through the execution of a macro. The hardware chosen by the system 100 is constrained by the hardware included in the hardware cost data 109. Since the system 100 provides a cost estimate, a user of the system 100 should not take the hardware selections as final. Rather, they should examine the bill of materials 115 for consistency and reasonableness and make substitutions or adjustments as necessary. The bill of materials 115, which is preferably embodied as a table has the following attributes: system number from the performance model 105, quantity, item description, hardware, software, disk storage designator (H, S, D), unit cost, and the total cost.

The life cycle cost model 113 is generated as a pivot table in another database (not shown), such as, for example, a Microsoft® Access™ database available from Microsoft Corp., WA, USA. For example, once the cost records 114 are loaded into an Oracles database, for example, they are exported to a Microsoft® Access™ database for the sole purpose of taking advantage of the pivot table capability. A release processing macro is executed in this exchange that understands the rules surrounding hardware choices from increment to increment and when to replace hardware and when to upgrade hardware. The cost records 114 remain in the Oracle® database for subsequent analysis via SQL queries.

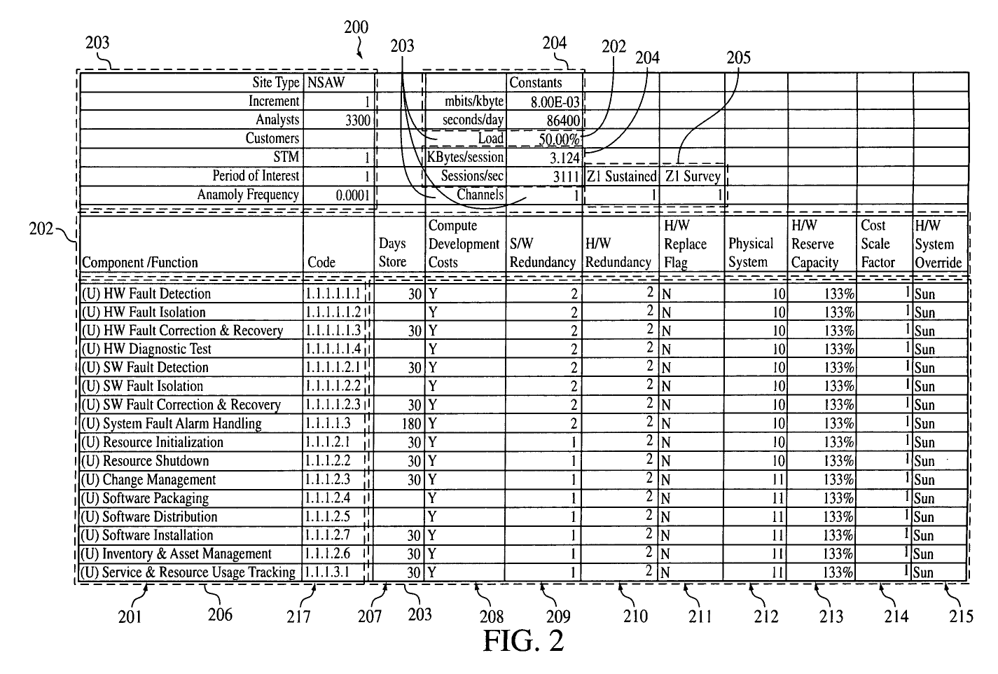

FIGS. 2 through 9 illustrate examples of various worksheets used in conjunction with the system 100 (of FIG. 1). The various descriptions and numeric values provided in the various worksheets given in FIGS. 2 through 9 are for illustrative purposes only, and the embodiments of the invention are not limited to any particular description or numeric value.

FIG. 2 shows a portion of the worksheet 200 of the performance model 105. The left hand portion of the performance model worksheet 200 shows the physical structure of the worksheet parameters that apply to individual component and functions of the model. The leftmost column 201 of the worksheet 200 includes identifiers for data in the columns to the right. The identifiers are a list of the component and functions identified in the SV4. The bottom of the list includes some “pseudo-services” as a means to mandate system components that otherwise would not be included. These pseudo-services include storage, communications equipment, and firewalls. At each intersection where involvement is indicated three relationships are determined and recorded: (1) the computer demand for a system component and function measured in SPEC-INT seconds or SPEC-FP seconds; (2) the volume of permanent storage that is stimulated by an execution of the system component and function; and (3) the volume of external communication that is stimulated by an execution of the system component and function.

The performance model 105 records many of the data/parameters that are used in the system 100 (of FIG. 1). In the performance model worksheet 200, there are shown headings cells 202, parameters cells 203 that a user is expected to set, constants/values cells 204 that are not expected to be changed by a user, extracted values cells 205 that contain values extracted from another portion of the model and preferably should not be changed once established in a construction of the model, relationships cells 206 that contain relationships and calculations that support the model; many times these values are of interest to the modeler.

Parameters that apply to the entire instance of the model include the following data that is recorded in cells 203 in the upper portion of the performance model worksheet 200 and applies to all component and functions in the current instantiation of the model. These include: Site Type—identification data; Increment—identification data; Analysts—count of analyst users that influences software licensing and work the system must support; Customers—count of customers that influences software licensing and work the system must support; input communication volume that influences work the system must perform; Period of interest—the period of time being studied by the model (in seconds); Anomaly frequency—a ratio (ex., 1 in 10,000) that is used to adjust frequency for component and function that are irregular, such as the frequency of a system anomaly, wherein each system component and function can have a unique anomaly frequency; Load—percentage of input volume that includes processable data; and Channels—count of input volume channels that are present at the site.

This list of data may change if the system 100 is applied to a different system. In FIG. 2, the left hand portion of the performance model worksheet 200 shows the physical structure (component/function 201 and code 217) of the worksheet parameters that apply to individual component and functions of the model. The following classes of data are recorded in nine columns 202 with the headings listed below. The data values are recorded in cells 203 in the same row with system components in the performance model cells 206. Each row's settings may be different; these settings directly influence how the model behaves. These columns 202 include Days Store 207—days to retain data at this site, generated by this component and function; Compute Development Cost 208—a flag telling the model whether to calculate the development cost, this is generally only set to yes in one of the sites in a system of systems environment; S/W (software) Redundancy 209—level of software redundancy required for this component and function, this is an integer value; H/W (hardware) Redundancy 210—level of hardware redundancy required for this component and function, this is an integer value; H/W Replace Flag 211—a flag used in a later calculation that specifies if this increment's hardware cost will be adjusted for upgrades, yes or no. No directs that the model will adjust the current increments cost to account for upgrades rather than replacement; Physical System 212—the modeler enters a system number in this cell: those component and functions with the same system number will operate on the same physical platform. The SV1 is one of the sources of this information; H/W Reserve Capacity 213—the modeler enters a percentage that reflects how much hardware reserve capacity is required for this component and function. The number is represented a 100%+Reserve Capacity, i.e. 133% requires 33% reserve; Cost Scale Factor 214—this value is a factor that directly changes the cost of each element in the cost calculator 106. This value is normally set to 1; and H/W System Override 215—this cell is where a system engineer or an architect can mandate a specific manufacturer or piece of hardware for a system component and function.

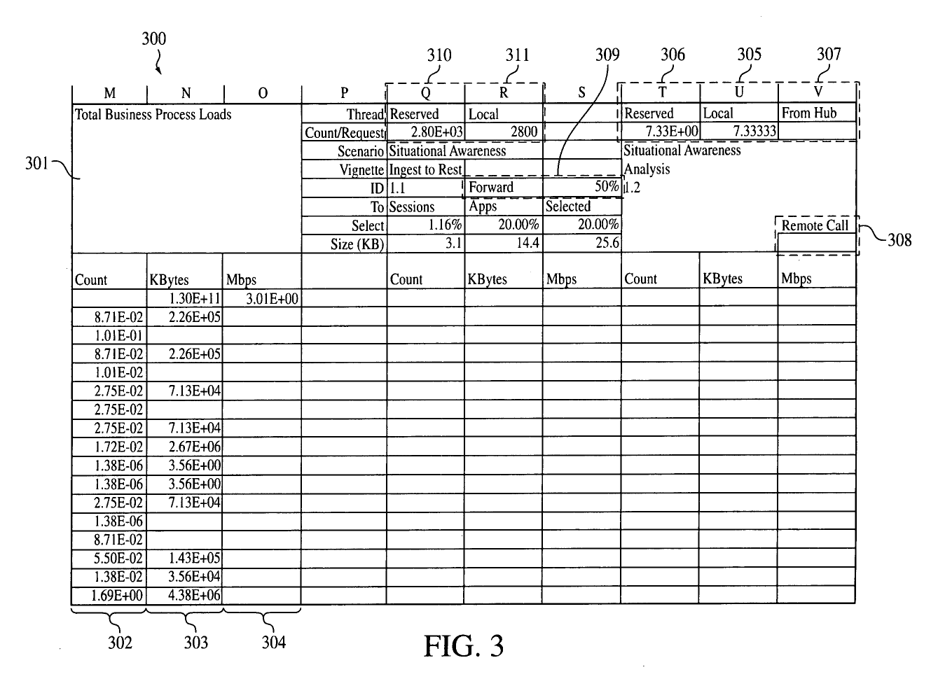

FIG. 3 (with reference to FIG. 1) illustrates output values of the performance model 105 that are passed on to the cost calculator 106 and two of the mission activities. In FIG. 3, the Total Business Process Loads 301 starts in column M, labeled ‘Count’, each entry represents (1) a summation of the ‘Count’ cells (total count of component and function executions) across all mission activities, a sum of the Count column 302 is given in row 10 of this column. Total Business Process Loads 301 continues in column N, labeled ‘KBytes’, each entry represents a summation of the ‘KByte’ cells; (2) (total permanent storage generated) of each component and function across all mission activities with consideration for the Days Stored (of FIG. 2), where a product of the sum of the KBytes columns 303 is given in row 10 of this column, and where the total Business Process Loads 301 continues in column O, labeled Mbps, each entry represents a summation of the ‘Mbps’ cells; (3) (total external communications stimulated) of each component and function across all mission activities, where a sum of the Mbps columns 304 is given in row 10 of this column.

Each mission activity has three columns assigned to it. FIG. 3 shows two example mission activities identified by a scenario and a vignette; the scenario is ‘Situational Awareness’ and the vignettes are ‘Ingest to Rest’ and ‘Analysis.’ There are four cells near the tops of the three columns that contain parameters that are set/updated depending on the specific construction of the model. These cells include “Local” (cell 305)—a count of executions of this mission activity from this mission activity's direct stimuli. To the left of this cell 305 is a cell 306 entitled “Reserved”, which is a relationship that calculates the execution of the mission activity from all stimuli, including the local stimuli. For example, some mission activities may use other mission activities as part of their execution so that the count of total executions is the sum of the independent executions plus the count of executions stimulated from other mission activities. This relationship information is gleaned from the OV6c and used by the system 100 (of FIG. 1) to get an accurate count of a mission activities contribution to total system resource consumption. Another cell 307 (in FIG. 3) is provided entitled “From Hub”—this is the count of executions of the mission activity at the central site. This value is taken from the central site workbook. Another cell 308 is called the “Remote Call”—this is the percentage of the From Hub value 307 that will be executed at this remote site. The product of From Hub 307 and Remote Call 308 is the number of executions to add to locally stimulated count. For example, in a distributed system many database queries will be executed at the site of initiation but may also be executed at remote sites to ensure a complete response to the query. Additionally, a cell 309 entitled “Forward” is provided—this is the percentage of retained communications to forward to the central site; the “Forward” value is unique to this sample instantiation of the model and is generally not applicable.

Each instance of the system of FIG. 1 will have some characterizations included in the structure to accommodate unique processing requirements. It can be determined which component and functions are required for execution of a mission activity by examining the SV-5. Each component and function is represented by a single row, each mission activity is represented by three columns, the intersection of a mission activity and a component and function is three cells under headings ‘Count’, ‘KBytes’, and ‘Mbps’ in FIG. 3. An algorithm is recorded that identifies the count of executions for this component and function in the ‘Count’ cell when a component and function is required for a mission activity. This is generally the value recorded in the Reserved cell 310 near the top of the column but may be fewer or more depending on the component and function. For example, an error handling service might not execute each time that a mission activity takes place; it would only execute if the service were in error for the execution of the mission activity. If there is permanent storage generated, then the cell 311 to the right in the subject component and function row will record that relationship based on the frequency and the volume of data generated, the volume is preferably recorded in KBytes. The OV7 is used as the source of data volume when available. Finally, if there is communication stimulated, then the cell to the right of the storage relationship will record the communications relationship and the volume of communications in Mbps.

If an OV6c has been completed, then a source of information is given that describes the relationship between mission activities. These relationships describe when a mission activity will stimulate the execution of a peer mission activity. During construction of the model each mission activity is examined to identify its stimuli. That relationship is expressed in the Reserved cell 310 near the top of the column.

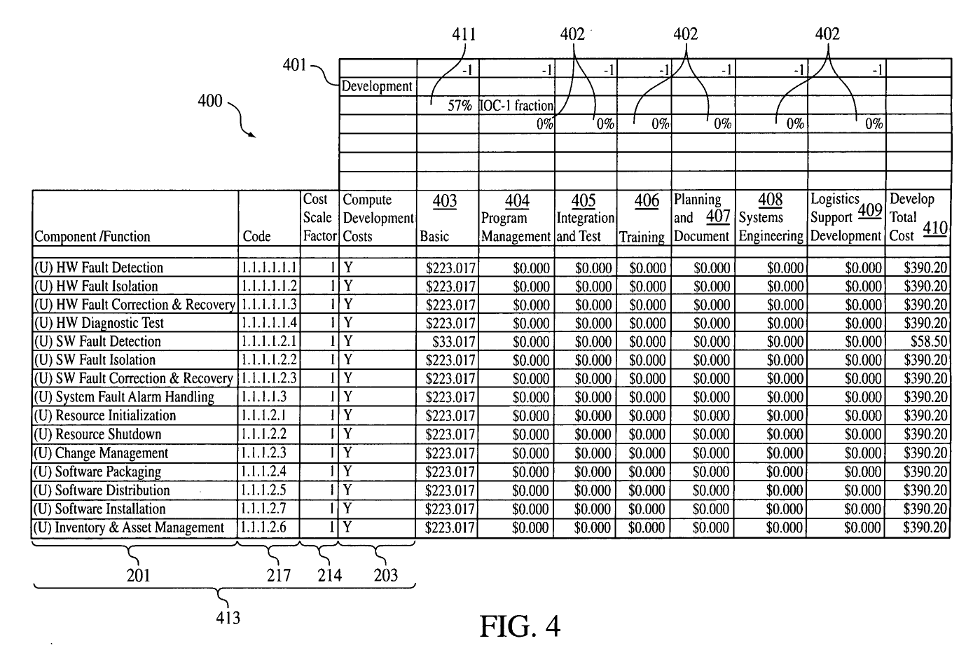

As mentioned, the cost calculator/accumulator 106 of FIG. 1 is an element of the system 100 that integrates the volume data determined in the performance model 105, the deployment plan 111, the hardware cost data 109, and the software cost data 110 to produce a set of cost records 114 and a bill of materials 115. Preferably, the cost calculator/accumulator 106 is a matrix with the rows being identical to those in the performance model worksheet 200 (of FIG. 2) and the columns representing a work-breakdown-structure represented in four major groups shown as worksheets in FIGS. 4 through 8: Development, Deployment, Operations and Re-Capitalization.

FIG. 4 represents the Development portion of the cost calculator/accumulator 106 (of FIG. 1). In FIG. 4, several of the columns of the worksheet 400 are copied directly from the performance model worksheet 200 (of FIG. 2). Two of the columns 201, 217 provide identification data, the third column 214 is the Cost Scale Factor, and the fourth column 203 is the Development Cost Flag. The data in these columns are copied from the corresponding columns in the performance model worksheet 200 (of FIG. 2) and should not be changed on worksheet 400. The development portion 401 of the first cost calculator/accumulator worksheet 400 is divided into four potential development periods. The periods are usually set to one year but can be changed to accommodate special circumstances. There are five columns entitled “Basic”. However, for ease of understanding, FIG. 4 only illustrates one “Basic” column 403, which represents the basic development cost for one development period, with three of the remaining four being an allocation of program development cost to each of the remaining development periods, and the fourth being the development cost for the entire program, wherein all periods do not have to be used. The allocation is controlled by a percentage figure recorded in row three of each “Basic” column, cell 411 of the Basic column 403 for each development period.

In FIG. 4, the left hand portion 413 of the cost calculator/accumulator worksheet 400 represents the structure used for collecting development costs. The remaining columns within the development portion 401 of the Cost Calculator/Accumulator identify development cost overhead. These include Program Management 404, Integration and Test 405, Training 406, Planning and Documentation 407, System Engineering 408, and Logistic Support Development 409. These values can be calculated as a percentage of the Basic cost in accordance with the cost equivalency ratio (CER) in cell 402 of each column. This approach is used if one is provided with an estimate of the technical labor for development by the software organization. An alternative, and the most preferred method, is to use a parametric model to predict the development/integration cost for the development of a system. With this method, only values in the Basic columns 403 are entered since the other costs are included in any parametric cost estimate. Details of the cost predictions for activities within development are part of the parametric cost estimation model and are provided separately as reports of the parametric model. Column 410 represents the “Development Total Cost”, and is the sum of all development costs to the left of column 410.

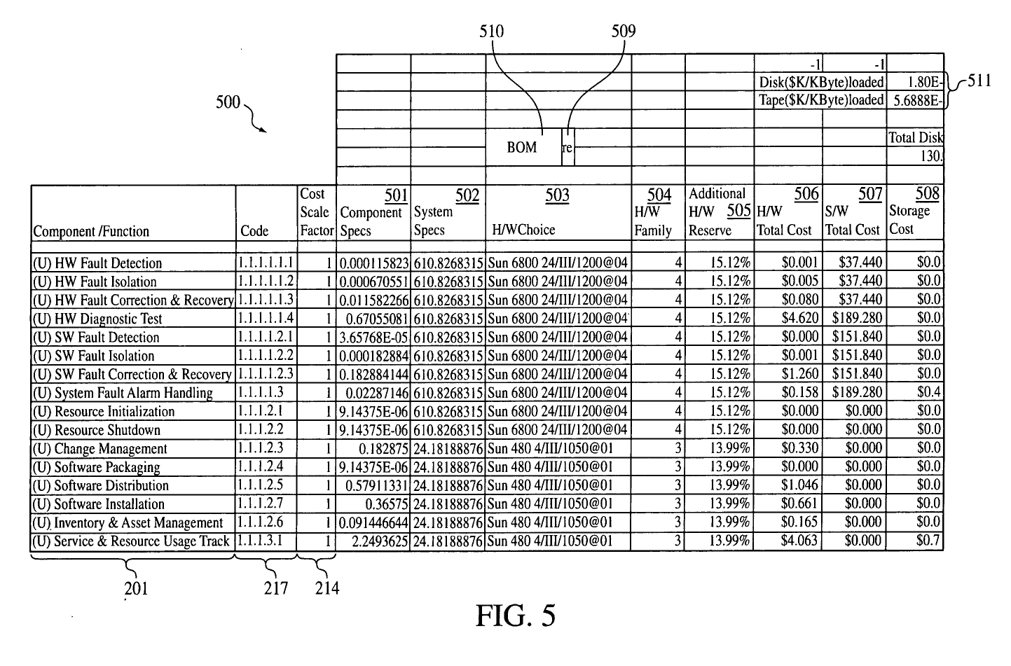

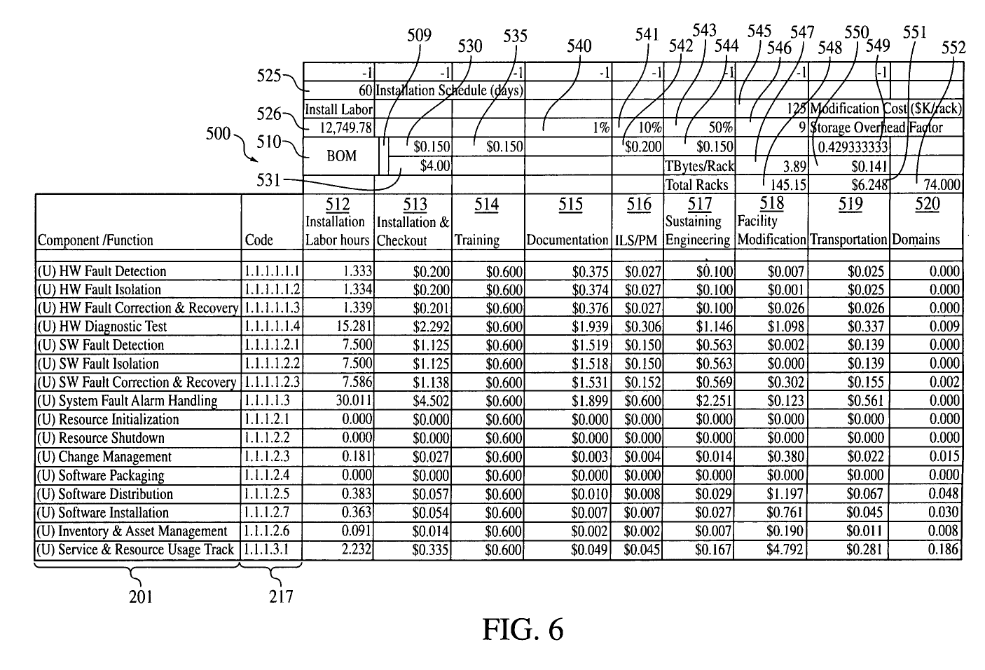

FIG. 5 illustrates the deployment worksheet 500 of the cost calculator/accumulator 106 (of FIG. 1). Worksheet 50Q illustrates one deployment period. There are three sub-sections of the deployment including the fixed data from the performance model worksheet 200 (of FIG. 2), values calculated from data in the performance model worksheet 200 (of FIG. 2), and calculations for the specific deployment costs. Again, fixed data (not shown in FIG. 5 or 6 for clarity) from the performance model worksheet 200 (of FIG. 2) includes S/W Redundancy 209, H/W Redundancy 210, H/W Replacement 211, Physical System 212, H/W Reserve Capacity 213, and H/W System Override 215. These values are recorded as an aid to users evaluating the model so that the principal values that influence the cost are visible on the same worksheet.

In FIG. 5, the Component Specs column 501 includes calculations in each row of column 501 that estimate the SPEC demand of each component and function. It is the product of (1) the total count 302 from the performance model worksheet 300 (of FIG. 3), (2) the sum of SPEC slope and SPEC intercept from the software cost data 110 (of FIG. 1), and the H/W Reserve Capacity 213 from the performance model worksheet 200 (of FIG. 2).

The System Specs column 502 in FIG. 5 includes calculations that sum the Component Specs values for all component and functions scheduled to run on the same physical platform. This summary value is the value used to make the hardware selection. The H/W Choice column 503 is populated using a macro named “PlatformSelector”. This macro is associated with the cost calculator/accumulator 106 (of FIG. 1) and is executed automatically at the end of a model run. It can be run manually by choosing the Select Hardware button 509 (which is partially hidden from view by the BOM button 510) on the worksheet 500. The PlatformSelector macro takes advantage of a selection process built into the hardware cost data 109 (of FIG. 1). The selection process is set to consider three factors in making the hardware selection: (1) ratio of the SPEC capacity of the computer to its cost; (2) the physical space required for the computer; and (3) the power (in watts) required for the computer to operate. Each of these can be assigned a weight to allow for a customer bias for one factor over another. Furthermore, additional factors can be included in the selection process.

Again with reference to FIG. 5, H/W Family 504 is a value copied from the hardware cost data 109 (of FIG. 1). Additional H/W Reserve 505 in FIG. 5 is a calculation of the amount of excess computing energy, over the reserve, based on the hardware selected. H/W Total Cost 507 calculates each component and function's portion of the cost of hardware. This is accomplished as the product of (1) the cost of the selected hardware from the hardware cost data 109 (of FIG. 1); (2) H/W Redundancy 210 from the performance model worksheet 200 (of FIG. 2); and (3) the ratio of the Component Specs 501 to the System Specs 502 (of FIG. 5).

The S/W Total Cost 507 in FIG. 5 calculates each component and function's cost of commercial software. This is accomplished as the product of (1) cost of the selected software from the software cost data 110 (of FIG. 1) (dependent on licensing strategy selected by the vendor); (2) S/W Redundancy 209 from the performance model worksheet 200 (of FIG. 2); and (3) the ratio of the Component Specs 501 to the System Specs 502 (of FIG. 5). The far right hand column 508 of FIG. 5 includes the calculations for Storage Cost. The two cells 511 include cost figures for disk storage and tape storage used for the Storage Cost calculations in the cells below. The cost is the product of data volume in Kbytes from the performance model 105 (of FIG. 1) and cost per Kbyte, from above in this column. Cost is represented in thousands of dollars per 1000 bytes ($K/Kbyte). Two buttons 509, 510 are visible on FIG. 5. These buttons 509, 510 are used to stimulate a reselection of hardware and to generate a new BOM.

FIG. 6 continues with the remainder of the deployment cost calculations where there are several input values, some output values and the same two buttons 509, 510 previously mentioned. The Installation Labor Hours column 512 has an input value in cell 525 that is used to specify the installation schedule in days. Cell 526 reports the total labor hours (the sum of the rows in column 512 associated with a component and function) necessary to perform the installation. Another cell, which is situated two rows down from cell 526 (not visible in FIG. 6 because the buttons 509, 510 have been displayed and cover the appropriate cell) calculates the team size needed to do the installation in the desired time duration. This calculation involves the labor necessary to install hardware, software and operating systems. Each of these is calculated individually and added in the formula recorded in the rows of column 512 associated with a component and function. Labor Hours are allocated to component and functions as the product of (1) the ratio of the Component Specs 501 to the System Specs 502 (of FIG. 5) and (2) the total Installation Hours, described earlier in this paragraph.

The Installation and Checkout column 513 has an input value in cell 530 that is the hourly cost of installation labor in thousands of dollars. Cell 531 is used to specify the number of hours required to install a partition of disk storage. This value is used in the calculation for Installation Labor Hours 512. The assumption for costing is that there is one disk partition for each computer domain. The costs calculated in column 513 are the values of the labor hours from column 512 times the rate given in cell 530. The Training column 514 has an input value in cell 535 that is the hourly cost of training staff. The remainder of the column 514 includes calculations to estimate the cost of training for each component and function. The values given in column 514 are calculated as the product of the training labor rate given in cell 535 and the respective hours of training, wherein the hours of training requirement are taken from the software cost data 110 (of FIG. 1) for function and application training. The software cost data 110 includes data and factors used in calculations associated with software, operation of software and the licensing strategies. Similarly, the hardware cost data 109 includes data and factors used in calculations associated with hardware and the operation of hardware.

The Documentation column 515 has an input value in cell 540, which is a CER that is applied to the cost of hardware, software, and storage. The remainder of the column 515 includes calculations to estimate the cost of documentation for each component and function, which is the product of the sum of hardware, software, and storage cost for a component and function; and the CER 540 for documentation. The ILS/PM (integrated logistics and program management) column 516 has an input value in cell 541, which is a CER that is applied to the installation labor hours 512 to determine the ILS/PM hours. Cell 542 is an input value that identifies the cost per hour, in thousands of dollars, of the staff that would provide this service. The remainder of the column 516 includes calculations to estimate the cost of ILS/PM for each component and function, which is calculated by the respective product of installation labor hours 512, ILS/PM CER 541, and ILS/PM labor rate 542.

The Sustaining Engineering column 517 has an input value in cell 543, which is a CER that is applied to the installation labor hours 512 to determine the sustaining engineering hours. Cell 544 is an input value that identifies the cost per hour, in thousands of dollars, of the staff that would provide this service. The remainder of the column 517 includes calculations to estimate the cost of sustaining engineering for each component and function. These calculations are calculated by the respective product of installation labor hours 512, sustaining engineering CER 543, and sustaining engineering labor rate 544.

The Facility Modification column 518 has three input values. In cell 545 there is a cost for facility modification to support installation of a single rack for equipment. Cell 546 includes a factor that represents the expected overhead associated with storing data on magnetic media. This number is used in cell 547 to calculate the effective utilization of a magnetic disk, where the value is represented as terabytes per rack. Cell 548 is an output value that identifies the total anticipated rack count of the site being modeled. The remainder of the column 518 comprises calculations to estimate the cost of facility modification associated with each component and function, which is calculated by the product of the sum of (1) storage rack count and hardware rack count; (2) facility modification rate per rack, and (3) the ratio of the Component Specs 501 to the System Specs 502 (of FIG. 5) in each cell of 518 associated with a component and function.

The Transportation column 519 has three input values, where the values are given as averages across all sites. In cell 549 there is a cost for airfare to sites for each person of the installation team. Cell 550 includes the daily per diem rate for the area that the site is in. Cell 551 includes the average cost to ship a fully configured rack to site. The remainder of the column 519 includes calculations to estimate the cost of transportation associated with each component and function. This calculation is accomplished in each cell of 519 associated with a component and function and is the sum of (1) the product of installation staff count and air fare, (2) the product of labor days and per diem rate, and (3) the product of the rack count and rack modification cost.

The Domains column 520 has no entry values. It reports the total domains for the site in cell 552. The remainder of the column 520 includes calculations to estimate the domain count for each component and function. This calculation is accomplished in each cell of 520 associated with a component and function and is the product of the host computer domain count, hardware redundancy 210 (of FIG. 2), and the ratio of Component Specs 501 to the System Specs 502 (of FIG. 5).

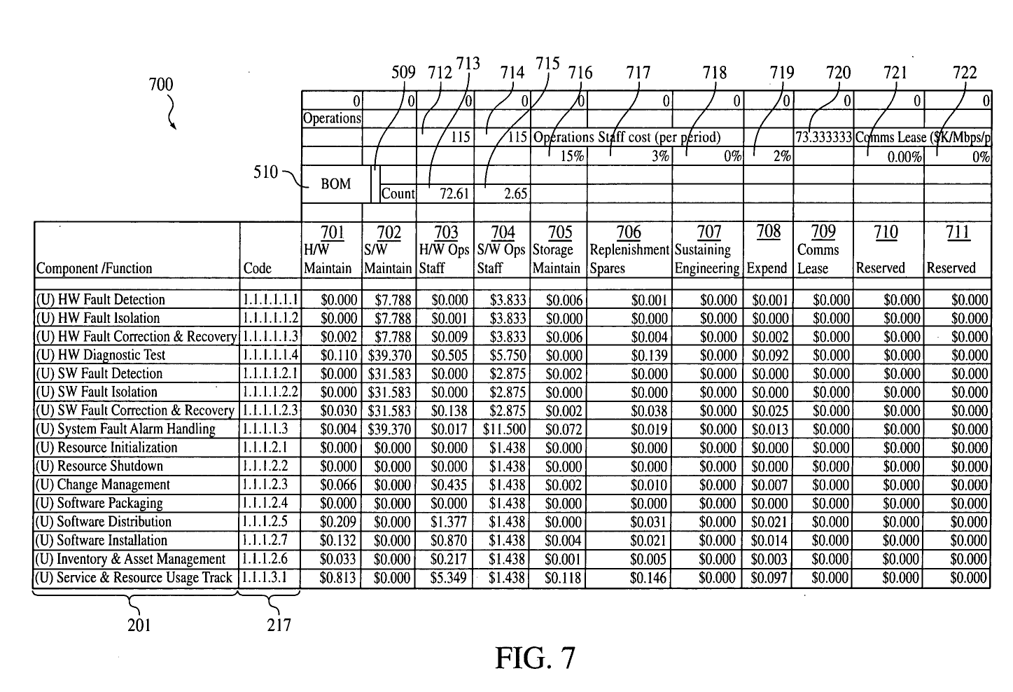

The operations portion of the cost calculator/accumulator 106 (of FIG. 1) is illustrated in FIG. 7, which depicts one period of operations cost. For the LCCE this cost is repeated for as many years as operations are expected to continue. The extension of cost through the operational life cycle is affected during the generation of the cost records 114 (of FIG. 1) at the end of a model run. There are values calculated based on data in the performance model 105, hardware cost data 109, software cost data 110, and the input values 712, 714, 716-722 at the top of the operations cost worksheet 700.

The H/W Maintain column 701 includes calculations to attribute each component and function portion of the hardware maintenance cost. This cost is the product of H/W Redundancy 210 (of FIG. 2), maintenance cost for the selected platform (from hardware cost data 109 in FIG. 1), and the ratio of the Component Specs 501 to the System Specs 502 (of FIG. 5). The S/W Maintain column 702 includes calculations to attribute each component and function portion of the commercial software maintenance cost. This cost is the product of S/W Redundancy 208 (of FIG. 2), the maintenance cost for the selected COTS software (from software cost data 110 in FIG. 1), and the ratio of the Component Specs 501 to the System Specs 502 (of FIG. 5).

The H/W Ops Staff column 703 includes calculations to estimate the cost of operations staff required to keep the hardware operational. Cell 712 is an input for the annual cost of a hardware maintenance person in thousands of dollars. Cell 713 shows the total count of required H/W operations staff necessary to keep the site operational. This cost is the product of the H/W Redundancy 210 (of FIG. 2), the maintenance staff required for the selected platform (from hardware cost data 109 in FIG. 1), operations staff cost from cell 712, and the ratio of the Component Specs 501 to the System Specs 502 (of FIG. 5).

The S/W Ops Staff column 704 includes calculations to estimate the cost of operations staff required to keep commercial software operational. Cell 714 is an input for the annual cost of a software maintenance person. Cell 715 shows the total count of required S/W operations staff necessary to keep the site software operational. This cost is the product of S/W Redundancy 209 (of FIG. 2), maintenance staff required for the selected software (from software cost data 110 of FIG. 1), operations staff cost from cell 714, and the ratio of the Component Specs 501 to the System Specs 502 (of FIG. 5). The Storage Maintain column 705 includes calculations to attribute each component and function portion of the storage maintenance cost. This cost is the product of storage cost 508 (of FIG. 5) attributed to each component and function, and the CER in cell 716 of this column 705.

The Replenishment Spares column 706 includes calculations to attribute each component and function portion of the storage maintenance cost. This cost is the product of storage cost 508 (of FIG. 5) attributed to each component and function, and the CER in cell 717 of this column 706. The Sustaining Engineering column 707 includes calculations to attribute each component and function portion of the sustaining engineering cost during operations. This cost is the product of hardware cost 506 (of FIG. 5) and storage cost 508 (of FIG. 5) attributed to each component and function, and the CER in cell 718 of this column 707. The Expend column 708 includes calculations to attribute each component and function portion of the expendables cost during operations. This cost is the product of 506 (of FIG. 5) and storage cost 508 (of FIG. 5) attributed to each component and function, and the CER in cell 719 of this column 708 includes calculations to attribute each component and function portion of the communication cost during operations. This cost is the product of Mbps 304 (of FIG. 3) and the CER in cell 720 of this column 708. In FIG. 7, the Comms Lease column 709, Reserved Column 710, and Reserved Column 711 are spare columns and serve to be adaptive to a particular customer's important pricing breakdown.

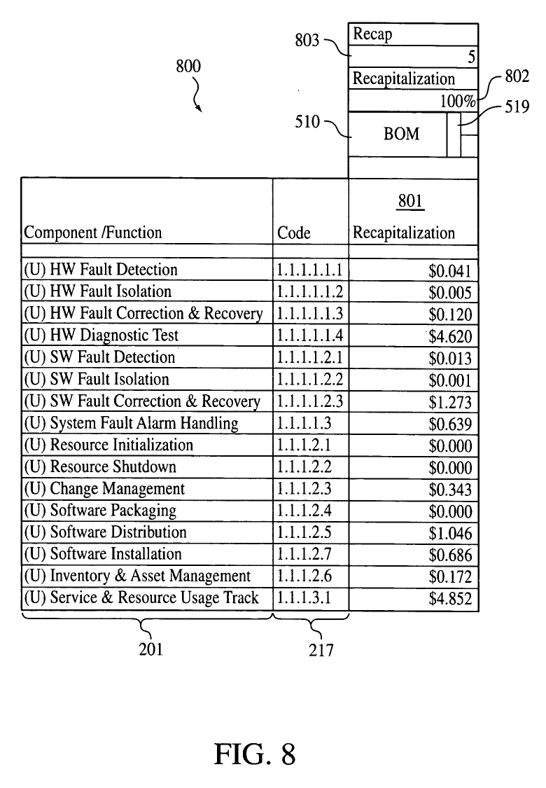

FIG. 8 illustrates the recapitalization worksheet 800 of the cost calculator/accumulator 106 (of FIG. 1). The second row 803 of worksheet 800 is where the recapitalization is recorded, in years, and as shown in FIG. 8 is set to five years, for example. There are values calculated in the recapitalization column 801 as the product of H/W Total Cost 506 (of FIG. 5), Storage Cost 508 (of FIG. 5), and the percentage value of recapitalization recorded in cell 802 (for example, 100%) at the top of the recapitalization column 801. The values recorded here are used in the algorithm that generates cost records 114 (of FIG. 1), where the recapitalization costs are associated with the appropriate year, considering which year the equipment was originally scheduled for installation.

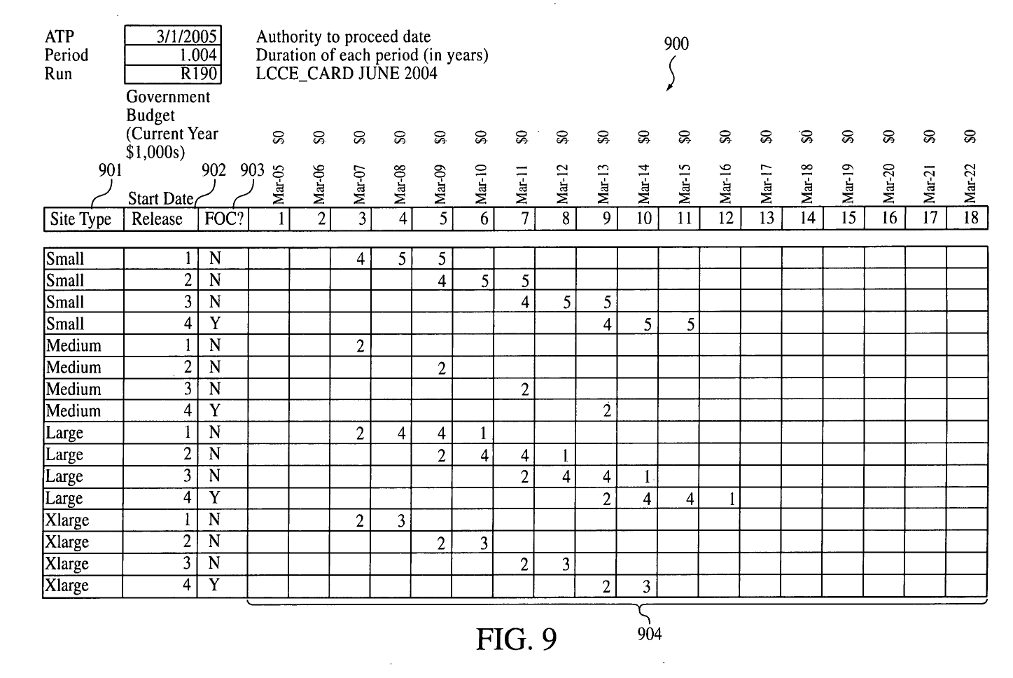

FIG. 9 shows an example of the worksheet 900 of the deployment plan 111 (of FIG. 1) in accordance with an embodiment of the invention. The deployment plan 111 (of FIG. 1) is input data to the model, whereby two kinds of input are provided. First, there is the list of model instantiations to include in the run. Typically, an instantiation is identified by site type 901 and by release 902. Also, one can identify whether the release is the final operating capability (FOC) 903. The second type of input is a deployment schedule 904 for each of the site/release instances. Data is provided by entering a count in a block to the right of the identification data that specifies the number of that type of site to install in the specified period. Periods are normally set to one year but can be adjusted to any desired length of time.

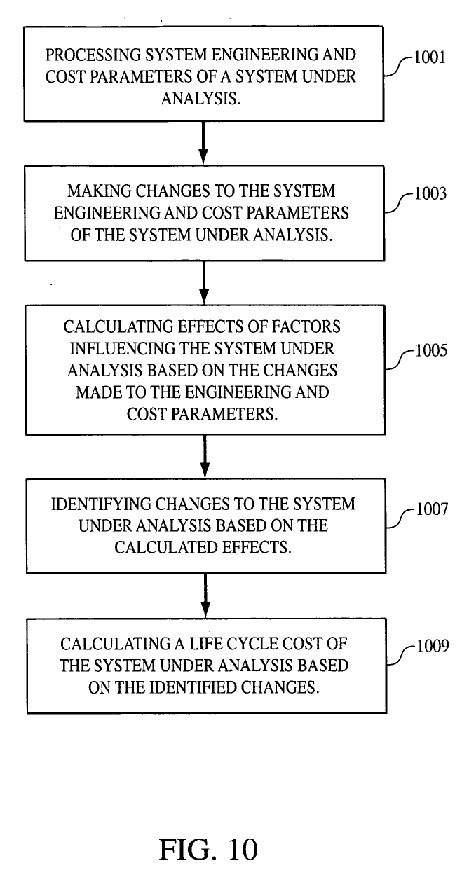

FIG. 10 illustrates a flow diagram of a method of conducting cost estimation for a system under analysis according to an embodiment of the invention, wherein the method comprises processing (1001) system engineering and cost parameters of the system under analysis; making (1003) changes to the system engineering and cost parameters of the system under analysis; calculating (1005) effects of factors influencing the system under analysis based on the changes made to the system engineering and cost parameters; identifying (1007) changes to the system under analysis based on the calculated effects; and calculating (1009) a life cycle cost of the system under analysis based on the identified changes, wherein the system under analysis comprises hardware architecture components. The factors comprise a cost effectiveness, space consumption, and power consumption of the system under analysis.

The identified changes to the system under analysis based on the calculated effects comprises hardware changes necessary to allow a software system of the system under analysis to function properly; and a cost associated with implementing the hardware changes. Additionally, the identified changes to the system under analysis based on the calculated effects further comprises any of a bill of materials of the hardware changes; an estimated time of deployment of the hardware changes; an estimated cost of deployment of the hardware changes; and an estimated operational cost of implementing the hardware changes.

The system engineering and cost parameters may comprise usage patterns comprising any of mission activity data related to business activities of the system under analysis, hardware architectural data of the system under analysis, and system engineering data of the system under analysis, wherein the mission activity data related to business activities of the system under analysis comprises any of a frequency of execution of component and function required for mission activities; permanent hardware storage required for execution of the mission activities; and communication components for the execution of the mission activities. Furthermore, the system engineering and cost parameters may comprise any of logical architecture, a logical data model, operations data, hardware cost data, software cost data, and a deployment plan.

The embodiments of the invention translate operational and functional design artifacts into physical system characteristics and life cycle costs. The embodiments of the invention provide business and engineering managers rapid insight into the design trades (both cost and performance) so that they can iterate to find a viable enterprise solution. Moreover, the embodiments of the invention provide a unique environment to understand the sensitivities in any decision and to immediately relate cost, performance, and schedule to mission needs. Furthermore, the embodiments of the invention also provide a wealth of other supporting data such as installation times, footprints, budget profiles, excess capacity, deployment schedules, etc.

The cost columns described in the various worksheets of FIGS. 2 through 9 are not limited to those elements provided therein, wherein the development costs can come from any source and not just SEER-SEM® (i.e., SEER-SEM® is used as an example of a cost estimation model used in conjunction with the embodiments of the invention). Accordingly, the embodiments of the invention may utilize any means to relate a resource capacity to a per transaction consumption of that resource, and may deal with any consumable resource (not just processing, storage, and communications). Furthermore, the analysis can exist at the operational level (OV-2, OV-5, and OV-6c) or the system level (SV-4, OV-5, and SV-10c) or any combination thereof, etc.

The embodiments of the invention can take the form of an entirely hardware embodiment, an entirely software embodiment or an embodiment including both hardware and software elements. In a preferred embodiment, the invention is implemented in software, which includes but is not limited to firmware, resident software, microcode, etc.

Furthermore, the embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

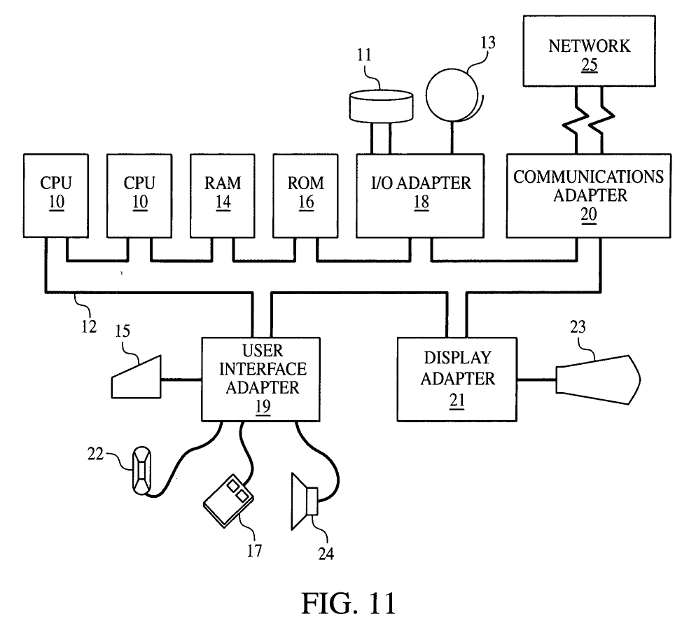

A representative hardware environment for practicing the embodiments of the invention is depicted in FIG. 11. This schematic drawing illustrates a hardware configuration of an information handling/computer system in accordance with the embodiments of the invention. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments of the invention have been described in terms of preferred embodiments, those skilled in the art will recognize that the embodiments of the invention can be practiced with modification within the spirit and scope of the appended claims.

What is claimed is:

1. An analytic system comprising:
an output system;
a calculation system operatively inputting data to said output system, wherein said calculation system is adapted to process system engineering and cost parameters of a system under analysis, make changes to said system engineering and cost parameters of said system under analysis, and calculate effects of factors influencing said system under analysis based on the changes made to said system engineering and cost parameters;
an input model system operatively inputting data to said calculation system; and
an input data system operatively inputting data to said calculation system and said output system,
wherein said output system is adapted to identify changes to said system under analysis based on the calculated effects, and calculate a life cycle cost of said system under analysis based on the identified changes.

2. The analytic system of claim 1, wherein said system under analysis comprises hardware architecture components.

3. The analytic system of claim 2, wherein said factors comprise a cost effectiveness, space consumption, and power consumption of said system under analysis.

4. The analytic system of claim 1, wherein the identified changes to said system under analysis based on said calculated effects comprises:
hardware changes necessary to allow a software system of said system under analysis to function properly; and
a cost associated with implementing said hardware changes.

5. The analytic system of claim 4, wherein the identified changes to said system under analysis based on said calculated effects further comprises any of:
a bill of materials of said hardware changes;
an estimated time of deployment of said hardware changes;
an estimated cost of deployment of said hardware changes; and
an estimated operational cost of implementing said hardware changes.

6. The analytic system of claim 1, wherein said system engineering and cost parameters comprise usage patterns comprising any of mission activity data related to business activities of said system under analysis, hardware architectural data of said system under analysis, and system engineering data of said system under analysis.

7. The analytic system of claim 6, wherein said mission activity data related to business activities of said system under analysis comprises any of:
a frequency of execution of a component and function required for mission activities;
permanent hardware storage required for execution of said mission activities; and
communication components required for said execution of said mission activities.

8. The analytic system of claim 1, wherein said system engineering and cost parameters comprise any of logical architecture, a logical data model, operations data, hardware cost data, software cost data, and a deployment plan.

9. A system comprising:
means for processing system engineering and cost parameters of a system under analysis;
means for making changes to said system engineering and cost parameters of said system under analysis;
means for calculating effects of factors influencing said system under analysis based on the changes made to said system engineering and cost parameters;
means for identifying changes to said system under analysis based on the calculated effects; and
means for calculating a life cycle cost of said system under analysis based on the identified changes.

10. The system of claim 9, wherein said system under analysis comprises hardware architecture components.

11. The system of claim 10, wherein said factors comprise a cost effectiveness, space consumption, and power consumption of said system under analysis.

12. The system of claim 9, wherein said system engineering and cost parameters comprise usage patterns comprising any of mission activity data related to business activities of said system under analysis, hardware architectural data of said system under analysis, and system engineering data of said system under analysis.

13. The system of claim 9, wherein said system engineering and cost parameters comprise any of logical architecture, a logical data model, operations data, hardware cost data, software cost data, and a deployment plan.

14. A method of conducting system engineering optimization for a system under analysis, said method comprising:
processing system engineering and cost parameters of said system under analysis;
making changes to said system engineering and cost parameters of said system under analysis;
calculating effects of factors influencing said system under analysis based on the changes made to said system engineering and cost parameters;
identifying changes to said system under analysis based on the calculated effects; and
calculating a life cycle cost of said system under analysis based on the identified changes.

15. The method of claim 14, wherein said system under analysis comprises hardware architecture components.

16. The method of claim 15, wherein said factors comprise a cost effectiveness, space consumption, and power consumption of said system under analysis.

17. The method of claim 14, wherein the identified changes to said system under analysis based on said calculated effects comprises:
hardware changes necessary to allow a software system of said system under analysis to function properly; and
a cost associated with implementing said hardware changes.

18. The method of claim 17, wherein the identified changes to said system under analysis based on said calculated effects further comprises any of:
a bill of materials of said hardware changes;
an estimated time of deployment of said hardware changes;
an estimated cost of deployment of said hardware changes; and
an estimated operational cost of implementing said hardware changes.

19. The method of claim 14, wherein said system engineering and cost parameters comprise usage patterns comprising any of mission activity data related to business activities of said system under analysis, hardware architectural data of said system under analysis, and system engineering data of said system under analysis.

20. The method of claim 19, wherein said mission activity data related to business activities of said system under analysis comprises any of:
a frequency of execution of a component and function required for mission activities;
permanent hardware storage required for execution of said mission activities; and
communication components for said execution of said mission activities.

21. The method of claim 14, wherein said system engineering and cost parameters comprise any of logical architecture, a logical data model, operations data, hardware cost data, software cost data, and a deployment plan.

22. A program storage device readable by computer, tangibly embodying a program of instructions executable by said computer to perform a method of conducting system engineering optimization for a system under analysis, said method comprising:
processing system engineering and cost parameters of said system under analysis;
making changes to said system engineering and cost parameters of said system under analysis;
calculating effects of factors influencing said system under analysis based on the changes made to said system engineering and cost parameters;
identifying changes to said system under analysis based on the calculated effects; and
calculating a life cycle cost of said system under analysis based on the identified changes.

23. The program storage device of claim 22, wherein in said method, said system under analysis comprises hardware architecture components.

24. The program storage device of claim 23, wherein in said method, said factors comprise a cost effectiveness, space consumption, and power consumption of said system under analysis.

25. The program storage device of claim 22, wherein in said method, the identified changes to said system under analysis based on said calculated effects comprises:
hardware changes necessary to allow a software system of said system under analysis to function properly; and
a cost associated with implementing said hardware changes.

26. The program storage device of claim 25, wherein in said method, the identified changes to said system under analysis based on said calculated effects further comprises any of:
a bill of materials of said hardware changes;
an estimated time of deployment of said hardware changes;
an estimated cost of deployment of said hardware changes; and
an estimated operational cost of implementing said hardware changes.

27. The program storage device of claim 22, wherein in said method, said system engineering and cost parameters comprise usage patterns comprising any of mission activity data related to business activities of said system under analysis, hardware architectural data of said system under analysis, and system engineering data of said system under analysis.

28. The program storage device of claim 27, wherein in said method, said mission activity data related to business activities of said system under analysis comprises any of:
a frequency of execution of a component and function required for mission activities;
permanent hardware storage required for execution of said mission activities; and
communication components for said execution of said mission activities.

29. The program storage device of claim 22, wherein in said method, said system engineering and cost parameters comprise any of logical architecture, a logical data model, operations data, hardware cost data, software cost data, and a deployment plan.
